(19) United States
(12) Patent Application Publication
(10) Pub. No.: US 2011/0118944 A1
(43) Pub. Date: May 19, 2011

(54) Vehicle and Method of Controlling Thereof

(76) Inventor: Ofer Tzipman, Moshav Bitzaron (IL)

(21) Appl. No.: 13/001,842

(22) PCT Filed: Jul. 1, 2009
(86) PCT No.: PCT/IL2009/000658

§ 371 Date: Dec. 29, 2010

Related U.S. Application Data
(60) Provisional application No. 61/077,187, filed on Jul. 1, 2008.

(51) Int. Cl. B62D 37/00; G06F 19/00

(52) U.S. Cl. 701/48

(57) ABSTRACT

A vehicle controlled by a driver comprises a primary chassis (22) supported by a road, a secondary chassis (16) movably linked to the primary chassis and at least one mechanism adapted for controlling movement of the vehicle. The controlling mechanism is adapted to change characteristics of vehicle movement and vehicle configuration according to a position of a body of the driver relative to the vehicle and a relative position of the primary (22) and secondary (16) chassis.

### FIELD OF THE INVENTION

The present invention generally pertains to a vehicle controlled by a driver, more specifically, a vehicle controlled according to an instantaneous position of a driver's body relative to the vehicle and relative position between vehicle's parts and according to a force applied to the vehicle, a driver and any part thereto.

### BACKGROUND OF THE INVENTION

Drive-by-wire (DbW) technology in the automotive industry replaces the traditional mechanical and hydraulic control systems with electronic control systems using electromechanical actuators and human-machine interfaces such as pedal and steering wheel emulators. Hence, the traditional components such as the steering column, intermediate shafts, pumps, hoses, fluids, belts, coolers and brake boosters and master cylinders are eliminated from the vehicle.

DbW technology has been hailed for liberating engineers to redesign the cabin, as well as for decreasing the risk of steering column related collision injury. It additionally allows for the steering human interface to take on unorthodox shapes and delivery methods. Still, for the most part the current DbW systems retain the traditional hand controlled steering interface familiar from conventional land and aviation vehicles.

Hand based steering human interfaces, and especially DbW ones, offer intuitive ease of use, however they can be challenging to the maintenance of balance of the vehicle and are notorious for not providing sufficient steering feedback. Furthermore, the driving experience they provide is largely a seated stationary one that may detract from the challenge of the driving experience.

It is therefore a long felt need to provide a human interface for a DbW steering system that offers increased balance as well a real sense of feedback to driver. Moreover, such an interface answers the desire for a fuller, more challenging driving experience.

### SUMMARY OF THE INVENTION

It is hence one object of the invention to disclose a vehicle controlled by a driver. The aforesaid vehicle comprises: (a) a primary chassis supported by a road; (b) a secondary chassis adapted for supporting said driver and movably linked to said primary chassis; (c) at least one mechanism adapted for controlling movement of said vehicle; (d) means for sensing at least one parameter selected from the group consisting of a relative position of said chassis, a relative position of a driver's body, a force acting on said chassis, a force acting on said body, a characteristic of vehicle movement.

It is a core purpose of the invention to provide the mechanism adapted to balance said primary chassis, said secondary chassis and said driver's body according to an instantaneous value of said sensed parameter.

Another object of this disclosure is to disclose the abovementioned invention wherein the secondary chassis is displaceable by said driver.

A further object of this disclosure is to disclose the abovementioned invention wherein the vehicle movement is controlled in accordance with a position of said secondary chassis.

A further object of this disclosure is to disclose the abovementioned invention wherein controlled movement is characterized by acceleration/deceleration of said vehicle in accordance with a position of said secondary chassis.

A further object of this disclosure is to disclose the abovementioned invention wherein the force is selected from the group consisting of centrifugal force, centripetal force, gravitation, acceleration, deceleration and any combination thereof.

A further object of this disclosure is to disclose the abovementioned invention wherein the sensing means is adapted for recognizing erratic vehicle movement and loss of vehicle grip in real time road conditions.

A further object of this disclosure is to disclose the abovementioned invention wherein the characteristic is selected from the group consisting of driving direction, velocity, acceleration, deceleration and any combination thereof.

A further object of this disclosure is to disclose the abovementioned invention wherein the controlling mechanism further comprises a steering unit; said vehicle is adapted for manually controlled steering in a manner separate from angular and linear displacement of said second chassis relative to said primary chassis.

A further object of this disclosure is to disclose the abovementioned invention wherein a linkage between said primary and secondary chassis is configured for variable angular and linear lateral displacements therebetween.

A further object of this disclosure is to disclose the abovementioned invention wherein a change in said instantaneous position is characterized by angular and linear displacements of said driver body relative to said secondary chassis and said secondary chassis relative to said primary chassis.

A further object of this disclosure is to disclose the abovementioned invention wherein the secondary chassis is adapted for compensating longitudinal and lateral road grade due to tilting thereof relative to said primary chassis.

A further object of this disclosure is to disclose the abovementioned invention wherein the secondary chassis further comprises stabilizing means; said means is adapted for stabilizing said secondary chassis in a predetermined position.

A further object of this disclosure is to disclose the abovementioned invention wherein the stabilizing means comprises at least one element selected from the group consisting of a gyroscopic stabilizer, a lever retractable stabilizer, an electromagnetic stabilizer, a magnetic stabilizer, a spring-operated stabilizer, a compressed gas stabilizer, servomotor-operated stabilizer and any combination thereof.

A further object of this disclosure is to disclose the abovementioned invention wherein the stabilizing means is adapted to provide a calibrated stabilized position of said secondary chassis in response to a predetermined instantaneous position of said driver body.

A further object of this disclosure is to disclose the abovementioned invention wherein the balance is achieved by controlling said vehicle characteristic selected from the group consisting of changing driving direction, velocity, acceleration, deceleration, tilting said secondary chassis relative to said primary chassis, calibrating stabilized position of said secondary chassis and any combination thereof.

A further object of this disclosure is to disclose the abovementioned invention wherein the vehicle further comprises computer means preprogrammed to control said mechanism to achieve said balance by controlling said vehicle characteristic selected from the group consisting of changing driving direction, velocity, acceleration, deceleration, tilting said secondary chassis relative to said primary chassis, calibrating stabilized position of said secondary chassis and any combination thereof.

A further object of this disclosure is to disclose the abovementioned invention wherein the computer means are adapted to balancing said vehicle according to force applied to said vehicle due to said erratic vehicle movement and loss of vehicle grip.

A further object of this disclosure is to disclose the abovementioned invention wherein the vehicle further comprises computer means preprogrammed to control said stabilizing means so that secondary chassis is stabilized in an optimal calibrated position relative to said primary chassis; said optimal calibrated position provides balancing said vehicle and gripping said road depending on said force applied to said vehicle and any part thereof. A further object of this disclosure is to disclose the abovementioned invention wherein the vehicle is adapted for neutralizing forces caused by change in said characteristics of said vehicle movement.

A further object of this disclosure is to disclose the abovementioned invention wherein the computer means is adapted for balancing said vehicle according to said force applied to said vehicle and said part thereof due to angular rotation of said secondary chassis about a longitudinal axis thereof and lateral linear shift relative to said primary chassis.

A further object of this disclosure is to disclose the abovementioned invention wherein the computer means is adapted for balancing said vehicle according to said force applied to said vehicle and said part thereof due to changes in vehicle movement.

A further object of this disclosure is to disclose the abovementioned invention wherein the computer means is adapted for controlling movement of said vehicle according to said force applied to said vehicle and part thereof.

A further object of this disclosure is to disclose the abovementioned invention wherein the vehicle further comprises computer means preprogrammed to control said stabilizing means so that secondary chassis is stabilized in an optimal calibrated position relative to said primary chassis; said optimal calibrated position provides balancing said vehicle and gripping said road depending on said momentary position of said driver.

A further object of this disclosure is to disclose the abovementioned invention wherein the linkage is adapted for fixating said primary and secondary chassis in a predetermined relative position.

A further object of this disclosure is to disclose the abovementioned invention wherein the vehicle is adapted for at least partially disabling said computerized means and at least partially steering said vehicle in a manual manner.

A further object of this disclosure is to disclose the abovementioned invention wherein a method of controlling a vehicle by a driver. The aforesaid method comprises the steps of: (a) providing said vehicle; (b) sensing at least one said parameter; (c) controlling at least one characteristic of vehicle movement; and (d) controlling relative position of said primary and secondary chassis.

It is a core purpose of the invention to provide the steps of controlling vehicle movement and relative position of said primary and secondary chassis comprising balancing said primary chassis, said secondary chassis and said driver's body and changing at least one characteristic of vehicle movement and relative position of said primary and secondary chassis according to an instantaneous position of a body of said driver relative to said vehicle value of said sensed parameter.

### BRIEF DESCRIPTION OF THE FIGURES

In order to better understand the invention and its implementation in practice, a plurality of embodiments will now be described, by way of non-limiting example only, with reference to the accompanying drawings, wherein

FIG. 1 is a schematic cross-section view of the human interface for controlling the movement of virtual and actual bodies;

FIG. 2 is a schematic top view of the human interface for controlling the movement;

FIG. 3 is a schematic front view of the human interface for controlling the movement on turn;

FIG. 4 is a schematic diagram of the forces applied to the human interface for controlling the movement on turn;

FIG. 5A is a schematic diagram of the forces applied to the untitled driver of the human interface for controlling the movement on turn;

FIG. 5B is a schematic diagram of the forces applied to the tilted driver of the human interface for controlling the movement on turn;

FIG. 6 is a schematic diagram of the vehicle arrangement; and

FIGS. 7A-B and 8A-B are schematic diagram of the relative positions of primary and secondary chassis during rectilinear and curvilinear motions.

### DETAILED DESCRIPTION OF THE PREFERRED EMBODIMENTS

The following description is provided, alongside all chapters of the present invention, so as to enable any person skilled in the art to make use of said invention and set forth the best modes contemplated by the inventor of carrying out this invention. Various modifications, however, will remain apparent to those skilled in the art, since the generic principles of the present invention have been defined specifically to provide a human interface for controlling a Drive by Wire system.

The term “Drive-by-Wire (DbW)” refers hereinafter to a technology that replaces traditional mechanical and hydraulic control systems with electronic control systems using electromechanical actuators and human-machine interfaces such as pedal and steering wheel emulators.

The term “controlling” refers hereinafter to influencing the spatial direction or the velocity of a body.

The term “chassis” refers hereinafter to a primary platform, constructed in a manner selected from a group consisting of: continuous matter, interleaving matter, weaved material, composition of bars or pipes, or any combination thereof, to which a plurality of elements that comprise a moving body, such as a vehicle, are attached.

The term “movement” refers hereinafter to any shift in the virtual or actual position of a body or parts thereof, including spatial shift, direction shift, facing direction shift, and velocity change.

The term “calibration” refers hereinafter to any readjustments to the data obtained from sensors or detectors, including complete disregard, in order to into account environmental or other factors that would otherwise cause unintentional and undesired instructions to said controlling system.

The driver is tilted with his seat/harness and footrests according to the forces acting upon his body in order to balance some of them, especially gravity and centrifugal forces. All the suspensions and wheels (angles/geometry in relation to the road surface) may not be affected by the mentioned tilting. The center of gravity of the vehicle and the driver is not shifted towards the wheels bearing most of the load, and the load on the mentioned wheels is reduced while the load on the wheels bearing less load is increased, compared to the same vehicle had it not had the tilting capability.

Balancing the load over the wheels and suspensions provides better road grip and ride comfort due to better performance of the tires and suspensions not being overloaded/underloaded. The suspensions and wheels not affected by the tilting result in optimal performance of the suspensions, tires and wheels. Tilting the driver's body results in better driving experience (similar to riding a bike) and driver's resistance to side forces for example (centrifugal force and acceleration/deceleration)

To assist in supporting the driver and secondary chassis in an upright or any other driver's desired position, a stabilizing system is needed which may be provided by springs disposed between the two chassis adapted for supporting the secondary chassis in an upright position. The driver is allowed to tilt the secondary chassis by changing his center of mass relative to the secondary chassis, A gyro within the secondary chassis or computer-controlled electro-mechanical system are also in the scope the current invention.

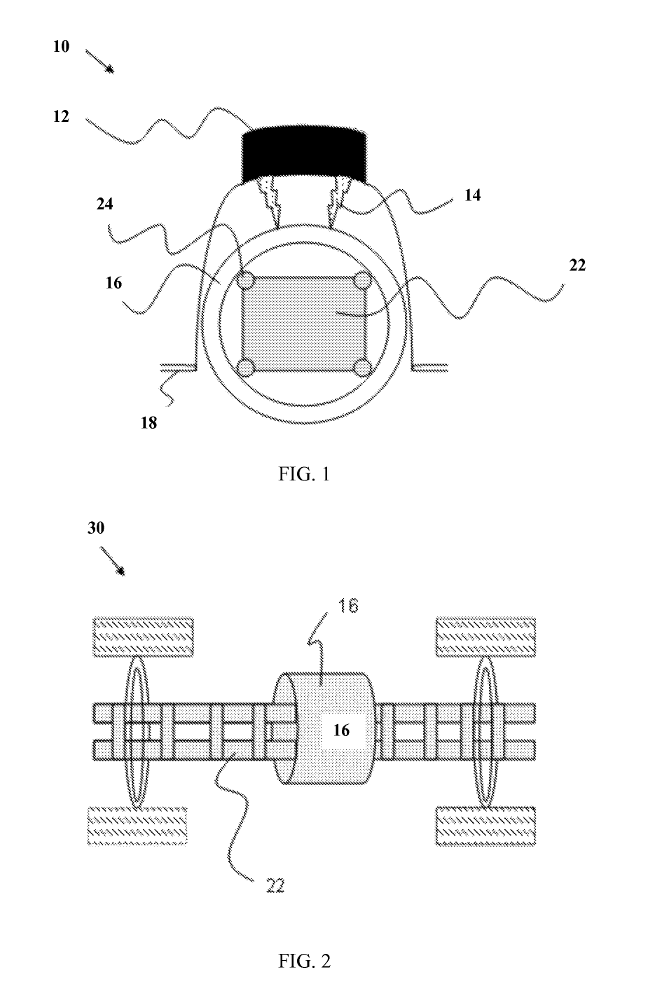

A computerized system may control the vehicle's direction by controlling the front wheels to assist in maintaining the driver's balance. For example, force-sensors in the secondary chassis sense side forces acting upon the sensors (and therefore upon the driver). If the driver is tilted more than necessary, the proposed system reckons the driver wishes to turn harder, the system may order the front wheels to turn harder in order to increase the centrifugal force to balance the side forces (in this case—too much gravity) acting upon the driver. Reference is made now to FIG. 1 illustrating a cross section view of human interface 10 for controlling a DbW system (not shown), in which the driver (not shown) seated on seat 12 places his feet within foot harnesses 18 embedded with mass shift sensors (not shown), said seat is interconnected to secondary chassis 16 which encloses primary chassis 22, thereby enabling the rotation of secondary chassis 16 by means of cogwheel mechanism 24 to counter imbalance of forces applied to the driver as the result of shifts in the direction of the vehicle.

In accordance with one embodiment of the current invention, the sensors (14) placed between the driver's harness (in this case seat and footrests), sense the displacement of the mass center (e.g. leaning to one side). The computer system, analyzes the sensor signals and decides that the driver wishes to tilt to the side. Then computer system may energize an electric motor, placed on the primary chassis. The aforesaid electric motor provided with a cogwheel at the rotor thereof rotates the secondary chassis by moving a coronet fixed to the secondary chassis.

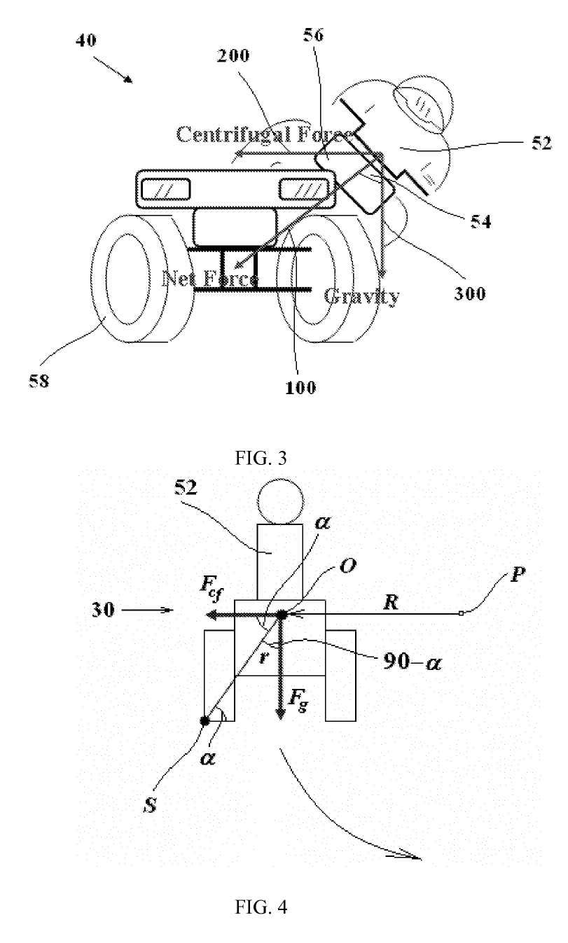

Reference is made now to FIG. 2 schematically illustrating a top view of the present invention embodied in vehicle 30, in which secondary chassis 16 encloses primary chassis 22, thereby enabling the rotation of said secondary chassis to prevent the vehicle from overturning while keeping all tires and suspensions at an optimal working geometry relative to the surface. It should be emphasized that better vehicle behavior is due to better distribution of the load over suspensions and wheels, and a better driver's experience Reference is made now to FIG. 3 schematically illustrating a front view of a preferred embodiment 40 of the present invention, in which a set of sensors (not shown) sense a resultant force 100 acting upon driver 52 that combines centrifugal force 200 and gravity force 300, and said sensor triggers turning vehicle's wheels or the rotation or tilting of secondary chassis (56) in order to achieve optimal angle 54 between said resultant force and said gravity force, in order to achieve balancing said driver and traction of vehicle wheels 58 and balance of vehicle.

Reference is now made to FIG. 4, presenting forces applied to the vehicle on turn. The point S indicates a point of vehicle overturning. If a vehicle moves along a curve of a radius R, it and, specifically, its driver 52 will be applied by two forces: a centrifugal force F_{cf} and gravity F_{g}.

The condition of overturning around the point S can be formulated as rF_{cf} sin α>rF_{g} cos α where r is a force arm defined as a distance between the points S and O (O is a center of mass), α is an angle between the force arm r and the ground surface. The moment of the force F_{g} is to be exceeded by the moment of the centrifugal force F_{cf}.

Formally, an overturning moment of the vehicle can be defined as M=M_{chassis}+M_{driver}. M_{driver} comprising components provided by the secondary chassis. It will be understood that M_{chassis} is constant. Thus, decreasing the overturning moment is provided by tilting the driver.

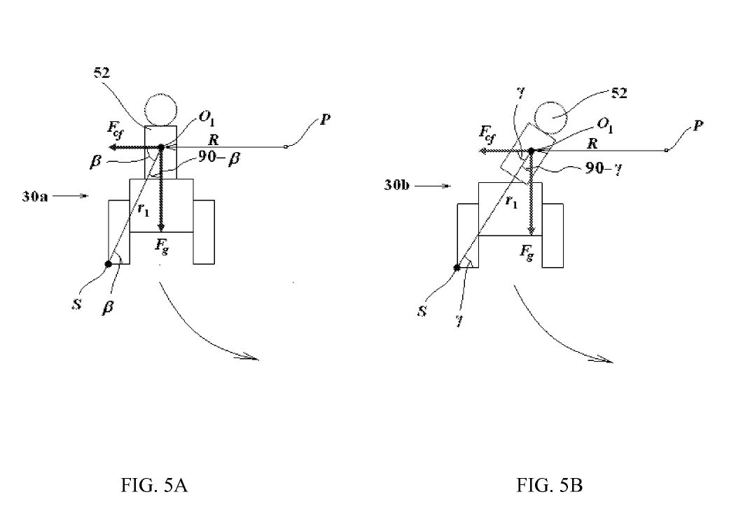

Reference is made now to FIGS. 5a and 5b schematically illustrating the forces applied to the driver 52 of conventional and proposed vehicles 30a and 30b, respectively) whilst performing a turning action at radius R.

The point O₁ indicates a mass center of the driver 52. Angles β and γ are angles between the force arm r₁ and the ground surface, β≧γ. Referring to FIGS. 5a and 5b, tilting the driver body results in decreasing the moment created by the centrifugal force F_{cf} because of the following in equation sin β>sin γ (β>γ). On the contrary, the moment of the gravity force increases with decreasing the tilt angle (cos β<cos γ). Thus, the balance of the force moments applied to the driver 52 is shifted along the radius R. Comparing FIGS. 5a and 5b, we conclude that tilting driver 52 by means of secondary chassis (not shown), decreases the moment created by the centrifugal force F_{cf}, and increases the moment created by gravity force F_{g}, providing better stability of the vehicle 30b with tilted position of the driver 52 relative to the upright positioned driver 52 in the vehicle 30a.

Due to the tilting, of driver 52 by means of secondary chassis (not shown) the moment created by the centrifugal force F_{cf}, is decreased and the moment created by gravity force F_{g}, is increased relative to an upright positioned driving position.

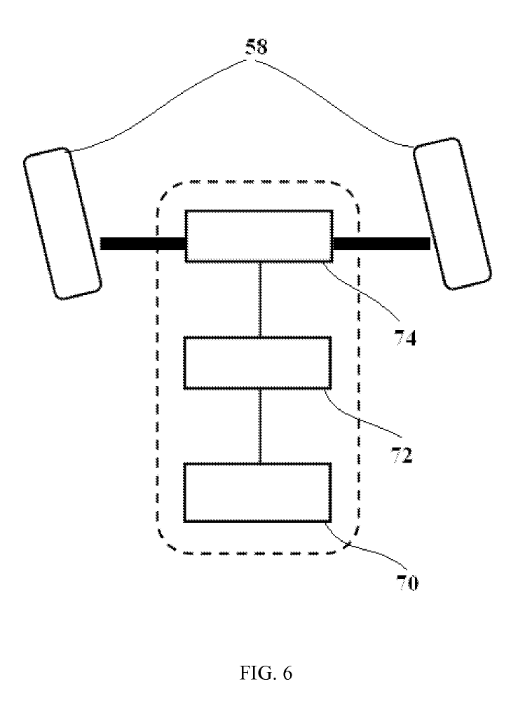

Reference is now made to FIG. 6, presenting an example of implementation the current invention. Specifically, a sensor 70 adapted for detecting a centrifugal force of the vehicle which resides at the secondary chassis (not shown) transmits an electrical signal corresponding to aforesaid centrifugal force to computer means 72. The computer means 72 is preprogrammed to control the steering mechanism (servo) 74 which steers forewheels to achieve balance of the forces acting on the vehicle.

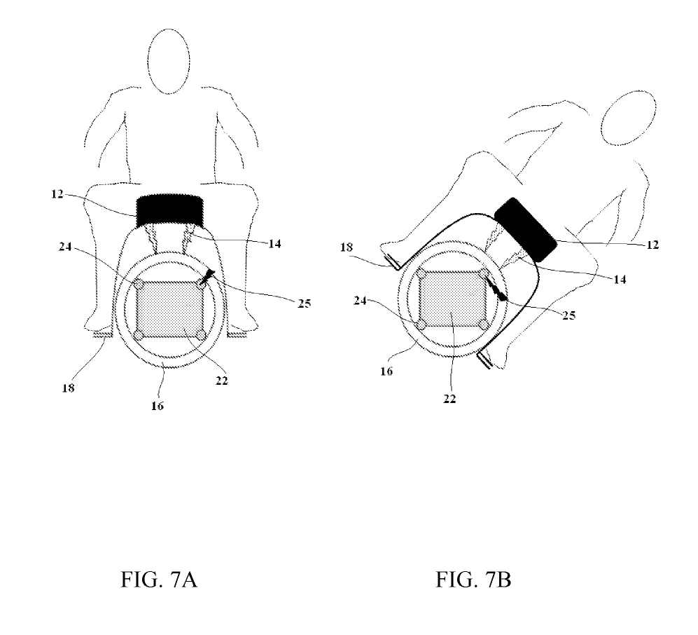

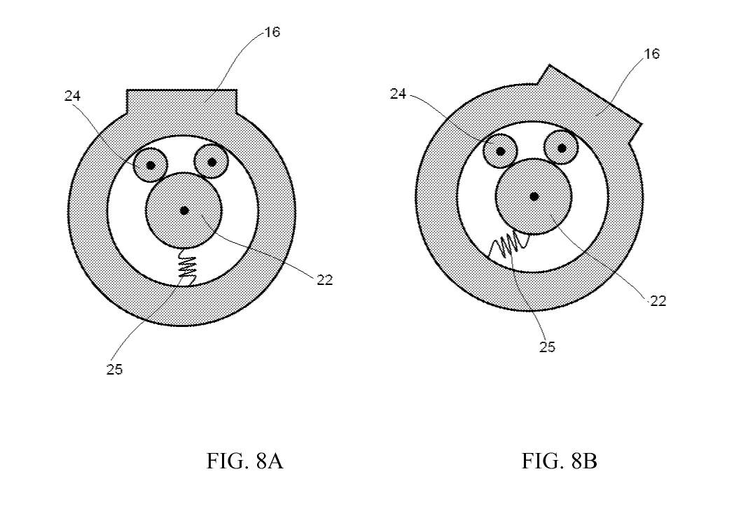

Reference is now made to FIGS. 7a-b and 8a-b, presenting an example of angular displacement of the secondary chassis 16 relative the primary chassis 22. A spring 25 stabilizes the driver, assisting him not to loose balance (due to gravity) and over tilt. Specifically, FIGS. 7a and 8a correspond to rectilinear motion of the vehicle and FIGS. 7b and 8b to the motion along an arc.

### BEST MODE

An interface for controlling a DbW steering system that is activated by shifting one's mass from side to side. Motion detectors integrated in the driver's seat sense the shift of mass and translate it by means of an interconnected computer system to a conventional DbW steering system. Moreover, the seat is additionally fitted with a tilting system that may receive tilting instructions from a computerized system in order to compensate for forces applied to the driver and maintain their sense of balance and in order to improve vehicle road handling.

### Example 1

A vehicle with a steering device. A driver's seat, foot rest, handles, or any similar means (hereby ‘a driver's harness’) are located on a separated body connected to the vehicle's body through a joint. The driver's driving orders are passed to the vehicle by mechanical, electrical, electronics, electromagnetic or wireless means. The driver maintains the balance of the harness by moving his body. The driver uses stirring aids (such as a handlebar, stirring wheel, or similar means) to command the vehicle's movement.

### Example 2

In addition to Example 1, a stabilizing aid is present to assist the driver in maintaining balance. This aid may be springs fixed to the driver's harness and the vehicle's body in a manner that support the driver's harness in its upright position.

### Example 3

In addition to Example 2, an accelerometer is embedded into the driver's harness, and adapted for sending signals to a computerized system which controls a motorized variable base. The springs are mounted to the variable base connected to the vehicle's body in a manner that allows each spring mount on the side of the vehicle's body to, independently of the other springs, change its distance to the driver's harness and by so apply force in a certain direction on the harness. The accelerometer signals are reset to the force applied when the harness is in its upright position while the vehicle is still and is placed on a horizontal surface (hereby ‘reset point’). Once signals from the accelerometer indicate force is applied in a direction other than the reset point, the computerized system orders the motorized base to move in a manner that applies force to the harness countering said direction.

### Example 4

Alternatively to Example 3, in addition to Example 2, detectors are placed in the driver's harness, sending signals to a computerized system which controls a motorized variable base. The springs are mounted to the variable base connected to the vehicle's body in manner that allows each spring mount on the side of the vehicle's body to, independently of the other springs, change its distance to the driver's harness and by so apply force in a certain direction on the harness. The detectors detect the driver's body position. Once signals from the detectors indicate the driver moved in a direction other than the centered point, the computerized system orders the motorized base to move in a manner that applies force to the harness in said direction.

### Example 5

In the embodiment described in Example 3, instead of springs, a rod is connected between driver's harness and the variable base. Once signals from the accelerometer indicate force is applied in a direction other than the reset point, the computerized system orders the motorized base to move in a manner that moves the harness countering said direction.

### Example 6

In the embodiment described in Example 4, instead springs, a rod is connected between driver's harness and the variable base. Once signals from the detectors indicate the driver moved in a direction other than the centered point, the computerized system orders the motorized base to move in a manner that moves the harness in said direction.

### Example 7

In the embodiment described in Example 1, an accelerometer is added to the driver's harness, sending signals to a computerized system which controls the movement (direction and speed) of the vehicle (Drive by Wire). The accelerometer signals are reset to the force applied when the harness is in its upright position while the vehicle is still and is placed on a horizontal surface (hereby ‘reset point’). Once signals from the accelerometer indicate force is applied in a direction other than the reset point, the computerized system moves the vehicle in said direction. The system may decide on said speed based on said force.

### Example 8

In the embodiment described in Example 7, the disclosed device includes the stabilizing aid depicted in Example 2.

### Example 9

In the embodiment described in Example 1, the disclosed device includes the stabilizing aid depicted in Example 3. The detectors are placed in the driver's harness, sending signals to a computerized system which controls the movement (direction and speed) of the vehicle (Drive by Wire). The detectors detect the driver's body position. Once signals from the detectors indicate the driver moved in a direction other than the centered point, the computerized system moves the vehicle in said direction. The system may decide on said speed based on said force.

### Example 10

In the embodiment described in Example 7, the disclosed device includes the stabilizing aid depicted in Example 4.

### Example 11

In the embodiment described in Example 9, the disclosed device includes the stabilizing aid depicted in Example 5 instead of the one depicted in Example 3.

### Example 12

In the embodiment described in Example 7, the disclosed device includes the stabilizing aid depicted in Example 6.

1-101. (canceled)

102. A vehicle controlled by a driver comprising:
(a) a primary chassis supported by a road;
(b) a secondary chassis adapted for supporting said driver and movably linked to said primary chassis;
(c) at least one mechanism adapted for controlling movement of said vehicle;
(d) means for sensing at least one parameter selected from the group consisting of a relative position of said chassis, a relative position of a driver's body, a force acting on said chassis, a force acting on said body, a characteristic of vehicle movement,
wherein said mechanism is adapted to balance said primary chassis, said secondary chassis and said driver's body according to an instantaneous value of said sensed parameter.

103. The vehicle according to claim 102, wherein said secondary chassis is displaceable by said driver.

104. The vehicle according to claim 102, wherein said vehicle movement is controlled in accordance with a position of said secondary chassis.

105. The vehicle according to claim 102, wherein said sensing means is adapted for recognizing erratic vehicle movement and loss of vehicle grip in real time road conditions.

106. The vehicle according to claim 102, wherein said controlling mechanism further comprises a steering unit; said vehicle is adapted for manually controlled steering in a manner separate from angular and linear displacement of said secondary chassis relative to said primary chassis.

107. The vehicle according to claim 102, wherein a change in said instantaneous position is characterized by angular and linear displacements of said driver body relative to said secondary chassis and said secondary chassis relative to said primary chassis.

108. The vehicle according to claim 102, wherein said secondary chassis is adapted for compensating longitudinal and lateral road grade due to tilting thereof relative to said primary chassis.

109. The vehicle according to claim 102, wherein said secondary chassis further comprises stabilizing means; said means is adapted for stabilizing said secondary chassis in a predetermined position.

110. The vehicle according to claim 109, wherein said balance is achieved by controlling said vehicle characteristic selected from the group consisting of changing driving direction, velocity, acceleration, deceleration, tilting said secondary chassis relative to said primary chassis, calibrating stabilized position of said secondary chassis and any combination thereof.

111. The vehicle according to claim 102, further comprising computer means preprogrammed to control said mechanism to achieve said balance by controlling said vehicle characteristic selected from the group consisting of changing driving direction, velocity, acceleration, deceleration, tilting said secondary chassis relative to said primary chassis, calibrating stabilized position of said secondary chassis and any combination thereof.

112. The vehicle according to claim 111 wherein said computer means is adapted for balancing said vehicle according to said force applied to said vehicle and said part thereof due to angular rotation of said secondary chassis about a longitudinal axis thereof and lateral linear shift relative to said primary chassis and changes in vehicle movement.

113. The vehicle according to claim 111, wherein said computer means is adapted for controlling movement of said vehicle according to said force applied to said vehicle and part thereof.

114. The vehicle according to claim 109, further comprising computer means preprogrammed to control said stabilizing means so that secondary chassis is stabilized in an optimal calibrated position relative to said primary chassis; said optimal calibrated position provides balancing said vehicle and gripping said road depending on said momentary position of said driver.

115. The vehicle according to claim 102, wherein said linkage is adapted for fixating said primary and secondary chassis in a predetermined relative position.
